(19) United States
(12) Patent Application Publication
(10) Pub. No.: US 2020/0262508 A1
(43) Pub. Date: Aug. 20, 2020

(54) Adjustable Offset Axle

(71) Applicant: Brent Lorscheider, Eugene, OR (US)

(72) Inventor: Brent Lorscheider, Eugene, OR (US)

(21) Appl. No.: 16/868,302

(22) Filed: May 6, 2020

(51) Int. Cl. B62K 25/02; B60B 35/00

(52) U.S. Cl. CPC B62K 25/02; B60B 27/023; B60B 35/004

(57) ABSTRACT

A one-piece adjustable offset axle has a large end, a concentric small end and an offset center section located between the large and small ends. The center section locates and connects the front wheel of a cycle to two front forks of the cycle. Rotation of the axle within the fork axle housings adjusts the front wheel rotational axis to a plurality of positions relative to the forks. Each front wheel axis position results in a unique combination of steering and handling characteristics for the cycle. The axle is adjusted then fastened and rotationally secured to the forks. The axle allows quick and easy adjustments to the steering and handling characteristics of a cycle. The position of the front brake caliper can be adjusted to correspond with the adjusted front wheel position.

### BACKGROUND

Motorcycles and bicycles are herein referred to as “cycles”, and cycles often utilize an axle to connect a front wheel to a first and a second front fork. The axle is secured by axle housings located at the bottom of the first and the second fork, the axle locates and supports the front wheel. The forks are often connected to a cycle frame with a steering stem and triple clamps. The horizontal location of a rotational axis of the front wheel is a factor in determining an important attribute commonly referred to as “trail”. The trail is the horizontal distance between the point where the wheel contacts the ground and the intersection of the steering stem axis with the ground. The wheel contact point is behind, or trails, the steering stem axis intersection, hence the term trail.

Increasing the trail makes a cycle more stable but more difficult to turn, while decreasing the trail makes a cycle less stable but easier to turn. The trail is generally fixed by the cycle manufacture, but it can be changed with aftermarket triple clamps that have a different offset, which changes the horizontal location of the front wheel rotational axis. The trail can also be altered by raising or lowering either end of a cycle, but raising or lowering either end of a cycle also changes the rake, which is another attribute that affects the steering and handling characteristics of a cycle. A simple and easy means of adjusting the trail is needed.

Disclosed is an offset axle and ancillaries that allow a rider to easily alter the trail by adjusting the position of the front wheel rotational axis. The offset axle and the fork height in the triple clamps can be adjusted in various combinations to alter only the trail, alter only the rake, or alter both rake and trail. These alterations allow a rider to fine tune the handling and steering characteristics of a cycle.

### SUMMARY

Disclosed is a one-piece rigid offset axle and ancillaries for connecting a front wheel of a motorcycle or bicycle, herein referred to as “cycle”. The axle is comprised of a cylindrical large end, a cylindrical small end concentric with the large end, and a cylindrical center section eccentric with, and offset from the large and small ends. The center section locates and supports the front wheel of the cycle. The axle connects the front wheel to a first and a second front fork of the cycle. The axle is received in an axle housing of the first fork and an axle housing of the second front fork. Rotation of the axle within the housings adjusts the front wheel axis of rotation to a plurality of positions relative to the forks. Each front wheel position results in a unique combination of steering and handling characteristics for the cycle. The axle is rotated to a desired rotational position, fastened with an axle fastener, and rotationally secured to the forks. The axle allows quick and easy adjustments to the steering and handling characteristics of a cycle. The position of the front brake caliper can be adjusted to correspond with the adjusted front wheel position.

### BRIEF DESCRIPTION OF THE DRAWINGS

A more particular description of the present disclosure will be rendered by reference to specific embodiments thereof that are illustrated in the appended drawings. It is appreciated that these drawings depict only typical embodiments of the invention and are therefore not to be considered limiting of its scope. Example embodiments of the invention will be described and explained with additional specificity and detail through the use of the accompanying drawings identified below.

FIG. 1A is a top view of an embodiment having a continuous large end step.

FIG. 1B is a section of FIG. 1A.

FIG. 2A is a top view of an embodiment having a large end flange.

FIG. 2B is section of FIG. 2A.

FIG. 3 is an embodiment having an axle nut received by a threaded bore of the small end.

FIG. 4 is an embodiment on an axle in two axle housings.

FIGS. 5A and 5B are views of an embodiment having rotational securement of the large end by structural engagement, optional redundant rotational securement of the small end, and an axially mounted brake caliper mount.

FIGS. 6A and 6B are views of an embodiment having rotational securement of the large end by structural and frictional engagement, and a radially mounted brake caliper mount.

### DETAILED DESCRIPTION

Reference will now be made to figures (FIGs.) wherein like structures will be provided with like reference designations. It is understood that the drawings are diagrammatic and schematic representations of exemplary embodiments of the present invention, and are neither limiting nor necessarily drawn to scale.

The embodiments described herein pertain to axles and ancillaries used to connect the front wheel to motorcycles and bicycles, herein referred to as cycles. For descriptive purposes only, the embodiments are presented to illustrate how the invention proposed herein could be applied to a motorcycle or bicycle, herein referred to as “cycles” and do not limit the application of this invention to other parts of a motorcycle or bicycle, or other cycle type.

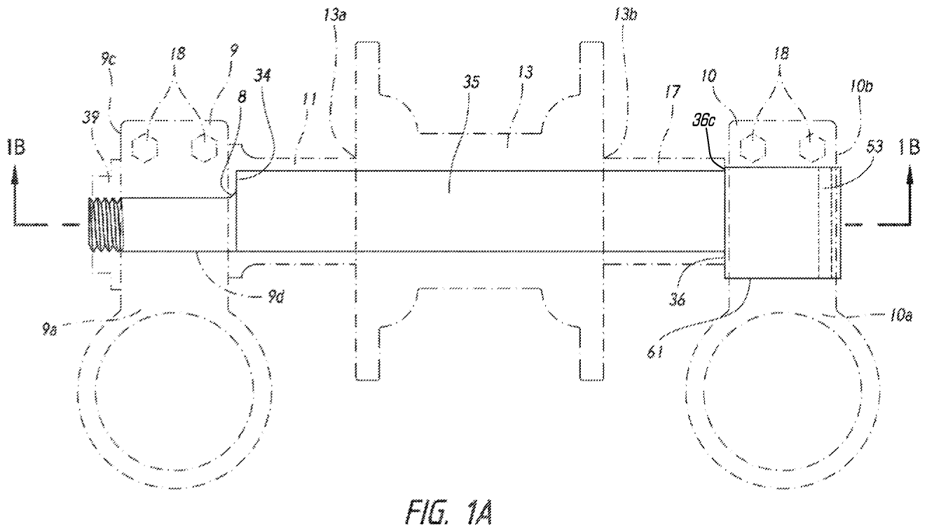

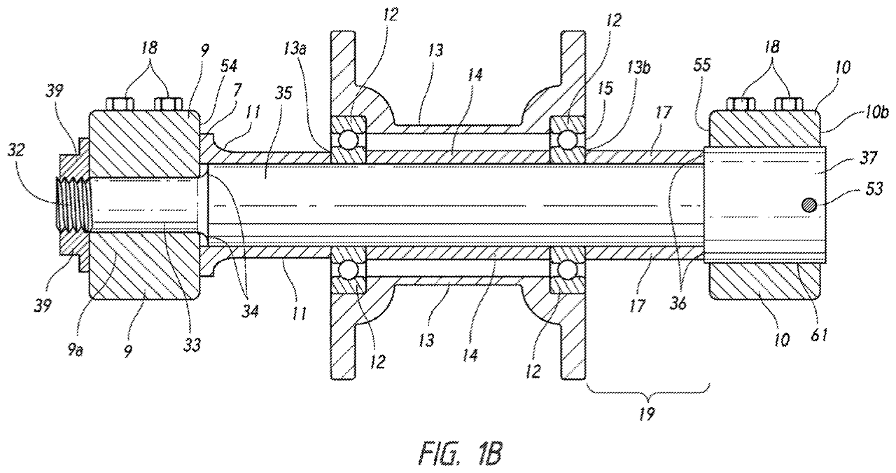

FIGS. 1A and 1B show an embodiment having a large end 37 configured to apply a first axial force by a large end step 36. The axle is housed a first fork split housings 10. Shown are a fastener nut 39, axle pinch bolts or pinch nuts 18, a small step 34, a small step fillet 8, a second spacer 11, a center section 35, a wheel hub 13 of a front wheel, a first side 13b and a second side 13a of the wheel hub, a first spacer 17, a large end step 36, a first fork bottom end 10a, a large end engagement feature 53, and a second fork bottom end 9a and the second fork split housing 9 having an inner face 54. The wheel hub 13 is supported on the center section 35 and is centered laterally between front forks by the second spacer 11 and the first spacer 17. The first fork split housing 10 has an inner face 55, an outer face 10b, and a bore 61. The second fork split housing 9, has an inner face 54, an outer face 9c, and a bore 9d. FIG. 1B shows a large end step range 19 extending from a point substantially inside the first housing inner face 55 to a bearing 12 of the first side 13b of the wheel hub.

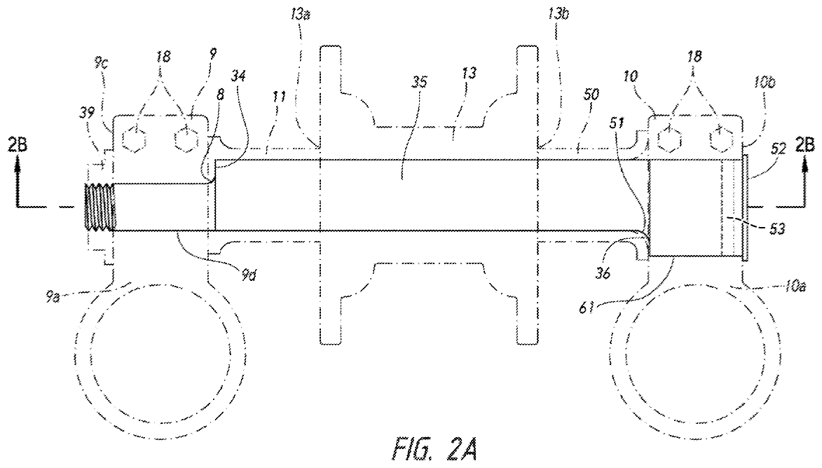

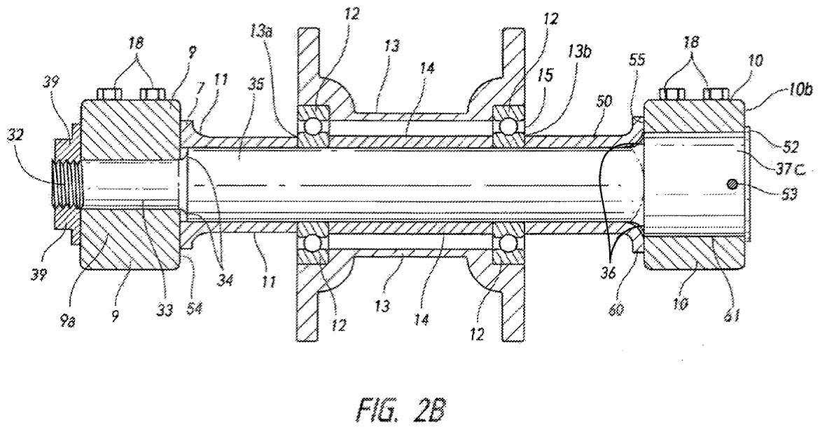

FIGS. 2A and 2B show an embodiment, having a large end configured to apply the first axial force with a large end flange 52. Shown are a fastener nut 39, axle pinch bolts 18, a small step 34, a small step fillet 8, a second spacer 11, a center section 35, a wheel hub 13 of a front wheel, a second side 13a and a first side 13b of the wheel hub, a first spacer 50, a large end step 36, a large end step fillet 51, a first fork bottom end 10a and first fork split axle housing 10, axle housing pinch bolts 18, a large end engagement feature 53, a second fork bottom end 9a, and second fork split axle housing 9. The wheel hub 13 is supported on the center section 35 and is centered laterally between front forks by the second spacer 11, the first spacer 50 and a first spacer flange 60. The first fork split axle housing has an inner face 55, an outer face 10b, and a bore 61. The second fork split axle housing has an inner face 54, an outer face 9c, and a bore 9d. For illustrative purposes only, the distally located fastener of the small end is a nut 39, that receives a threaded tip 32 of the small end. FIG. 2B shows wheel hub bearings 12, and a wheel hub spacer 14.

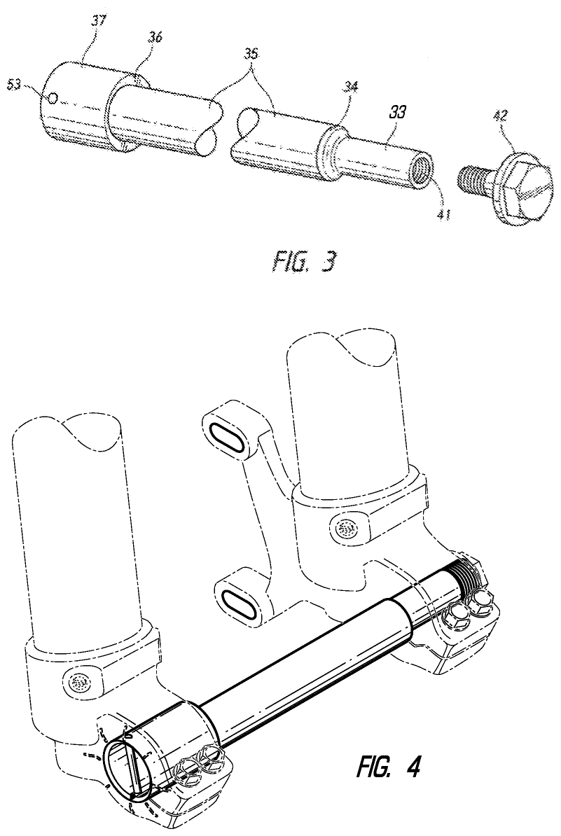

FIG. 3 is an embodiment having a fastener configured as a fastener bolt 42 received by a threaded bore 41 of the small end 33.

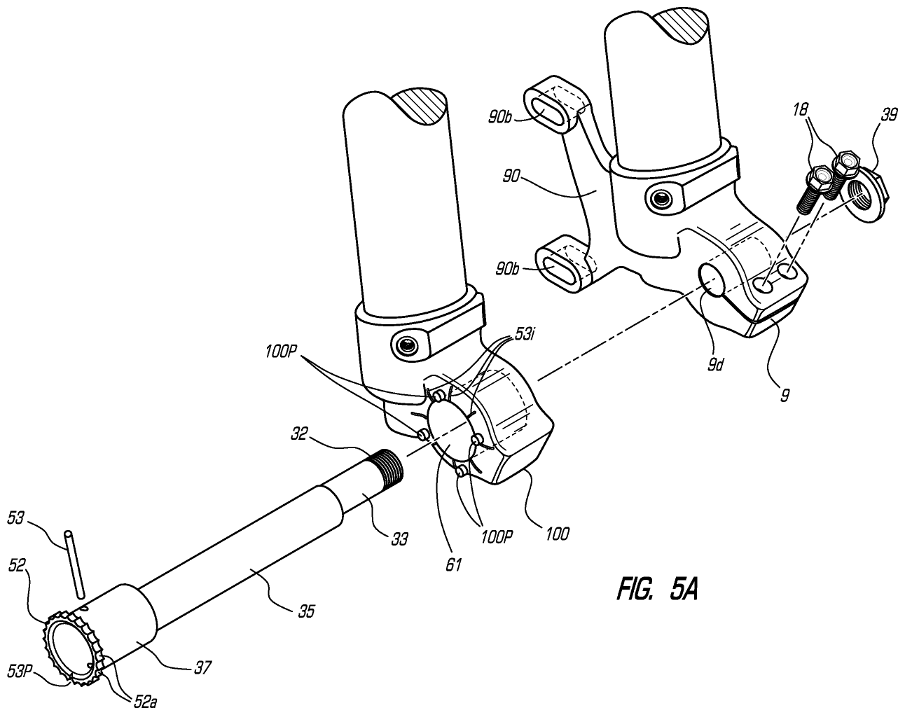

FIG. 4 is an embodiment housed in axle housings of the two front forks for the patent illustration.

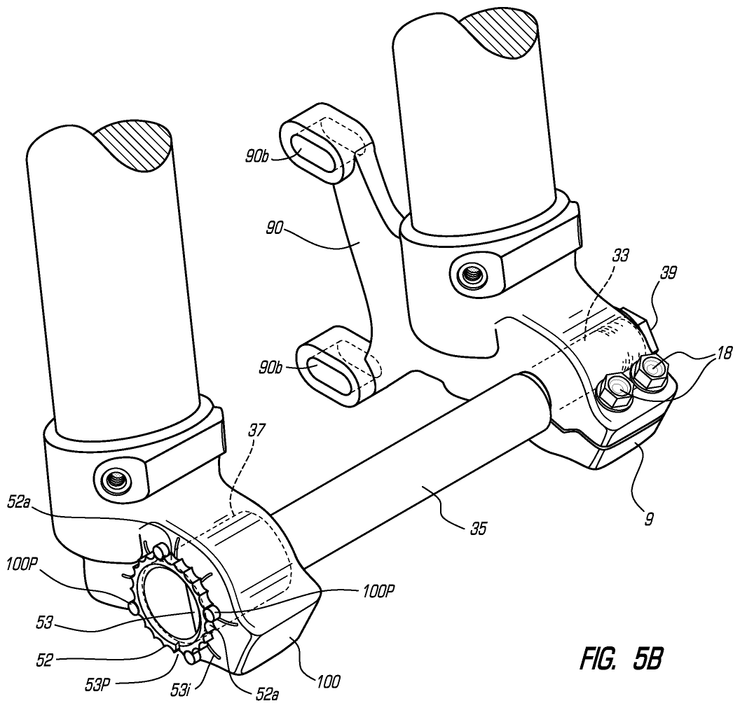

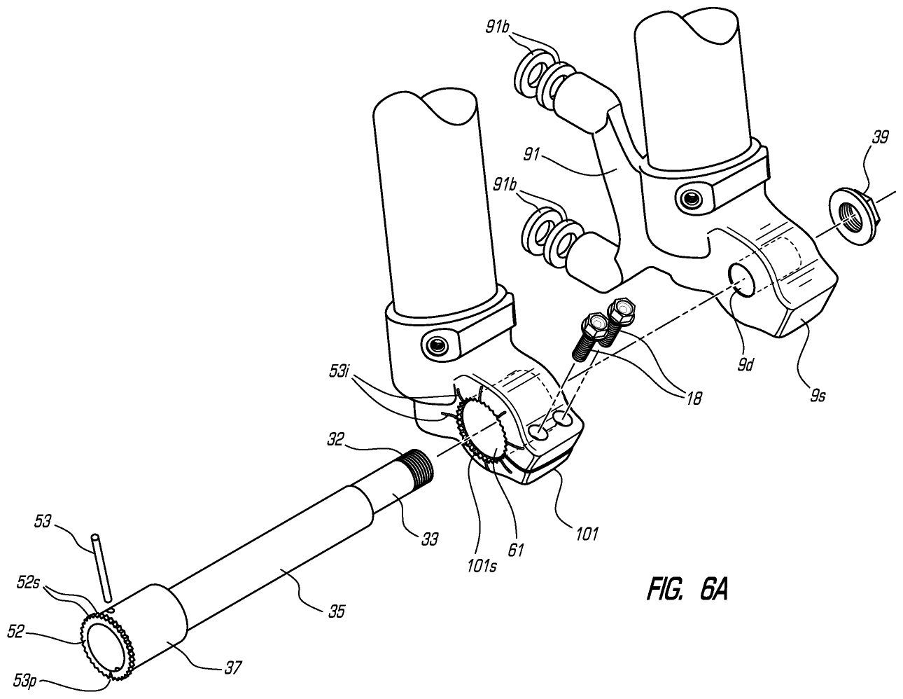

FIGS. 5A and 5B show an embodiment having rotational securement by structural engagement of a large end, optional redundant rotational securement of the small end, and an axially mounted brake caliper mount. Shown are axle pinch bolts 18, center section 35, a large end 37, a bore 61 of a first fork axle housing 100, first fork rotational engagement features 100p, large end flange 52 having rotational engagement arcs 52a, large end engagement feature 53, position locator feature 53p, a first fork position index 53i, a bore 9d of second fork split axle housing 9, axle nut 39, that receives threaded tip 32 of the small end 33, axial brake mount 90 with elongated holes 90b to allow any axial mounted front brake caliper to be located in a plurality of positions to correspond with a plurality of adjusted wheel positions.

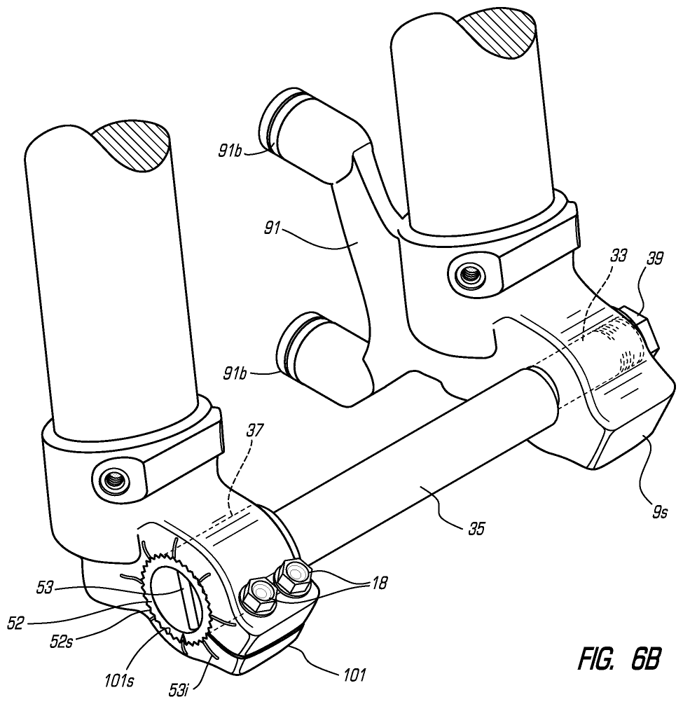

FIGS. 6A and 6B show an embodiment having rotational securement by structural and frictional engagement of the large end, and a radially mounted brake caliper mount. Shown are fastener nut 39, center section 35, a bore 61 of first fork split axle housing 101 with rotational engagement splines 101s, a large end 37 with rotation engagement splines 52s and engagement feature 53, a position locator feature 53p, a first fork position index 53i, second fork axle housing 9s, axle nut 39, that receives a threaded tip 32 of the small end 33, radial brake mount 91 with spacers 91b to allow any radially mounted front brake caliper to be located in a plurality of positions to correspond with a plurality of adjusted wheel positions.

The inventive includes an axle, and ancillaries. The ancillaries consist of axle housings, axle spacers, an axle fastener, and brake caliper mounts and spacers.

The axle has three cylindrical sections: a large end 37, a center section 35, and a small end 33. The small end is concentric with the large end, the center section is eccentric to and offset from both ends. The large end is separated from the center section by a large end step 36. The center section is separated from the small end by a small step 34. The large and small ends are connected respectively to a first front fork and a second front fork by an axle housing located at the bottom of the first fork and an axle housing located at the bottom of the second fork. The perpendicular distance of the center section offset is the offset distance. The offset range is twice the offset distance.

The axle is installed my inserting it through a first fork axle housing, a wheel hub, and a second fork axle housing. The axle may also pass through spacers located on either or both sides of the wheel hub that locate and support the wheel hub laterally. The center section locates and supports a wheel hub of the cycle wheel, the center section axis and the front wheel axis are located on the same line.

The axle is rotated in the axle housings by engagement of the large end engagement feature 53, the rotation moves the center section axis and front wheel axis about a circle relative to the forks when viewed from the side of the forks. Rotation of the axle in the axle housings adjusts the location of the front wheel axis to a plurality of positions relative to the forks. Adjusting the location of the front wheel axis of rotation to a desired position results in a desired combination of handling and steering characteristics of the cycle. The axle is rotated to the desired rotational position and rotationally secured.

For illustrative purposes only, FIGS. 1A, 1B, 2A and 2B show the embodiment with the rotational position secured by rotational securement of the large end 37 by direct frictional engagement by the bore 61 of a pinched split axle housing 10 of the first fork. Redundant optional rotational securement of the small end 33 is provided by direct frictional engagement of the small end 33 by the bore 9d of the pinched split axle housing 9 of the second fork.

For illustrative purposes only, FIGS. 5A and 5B show the embodiment with the axle rotational position secured by rotational securement of the large end 37 by direct structural engagement of the large end flange features 52a with engagement features 100p of the axle housing of the first fork. Optional redundant rotational securement of the small end 33 is provided by direct frictional engagement of the small end by the bore 9d of the pinched split axle housing 9 of the second fork.

For illustrative purposes only, FIGS. 6A and 6B show the embodiment with the axle rotational position secured by rotational securement of the large end 37 by structural and frictional engagement. The structural engagement is provided by direct engagement of the large end splines 52s by the splined bore 101s of the axle housing 101 of the first fork. The frictional engagement is provided by direct frictional engagement of the large end by the bore 61 of the pinched split axle housing 101 of the first fork.

It is obvious to a person having ordinary skill in the art that a plurality of features and configurations could be used to rotationally secure the axle to the axle housings. It is obvious to a person having ordinary skill in the art that a plurality of axle housing configurations could be used to pinch the axle in those embodiments having direct frictional engagement.

The large end is configured to apply a first inward axial force. For illustrative purposes only, FIGS. 1A and 1B show an embodiment with the large end configured to apply the first inward axial force by the large end step 36. FIGS. 2A and 2B show an embodiment with the large end configured to apply the first inward axial force by the distally located large end flange. It is obvious to a person having ordinary skill in the art that a plurality of large end configurations could be used to apply a first inward axial force, the first inward axial force ultimately applied to the bearing 12 of the first side 13b of the wheel hub.

The embodiment of FIG. 1A, shows the large end step 36 continuous because the large end diameter is substantially greater than the sum of the center section diameter and the offset range. The continuous large end step 36c provides continuous abutment about the entire circumference between the large end step and the first spacer 17. The large end step is located laterally within the large end step range 19 as shown in FIG. 1B. The large end step range extends from a point substantially inboard of the first axle housing inner face 55, to the bearing 12 of the wheel hub first side 13b.

The embodiment of FIGS. 2A and 2B has the large end flange 52 configured to apply the first inward axial force, the large end step 36 is located approximately at the inner face 55 of the first fork axle housing, the large end step does not abut the first spacer 50. The large end step has a fillet 51 to ease the inside corner of the large end step. The first spacer 50 directly abuts the first fork axle housing inner face 55 as shown in FIG. 2B, the flange 60 of the spacer has sufficient diameter and thickness to effectively bridge the bore 61 of the first fork axle housing and thereby provide continuous circumferential abutment of the flange of the spacer with the housing inner face.

It is obvious to a person having ordinary skill in the art that a plurality of configurations could be used for the large end, the large end step, the first spacer, the bearing of the first side of the wheel hub, and the first fork axle housing in order to transfer the first inward axial force applied by the large end to the bearing of the first side of the wheel hub.

The large end has an engagement feature to engage a tool to apply torque to the axle and to apply an axial force to extract the axle from an installed position. For illustrative purposes only, the embodiments of FIGS. 1A-2B and FIGS. 5A-6B have a large end pin 53 as the large end engagement feature, the pin fixed transversely across a hollow large end along the direction of the offset. It is obvious to a person having ordinary skill in the art that a plurality of feature configurations could be used to rotationally and axially engage the axle.

The large end has a position locator feature to indicate the rotational position of the axle and the resulting location of the center section axis relative to the first fork when viewed from the side. For illustrative purposes only, the embodiments disclosed in FIGS. 5A-6B herein utilize a position locator notch 53p as the large end position locator feature. The first fork has a position index feature 53i to reference the location of the position locater feature. It is obvious to a person having ordinary skill in the art that a plurality of configurations could be utilized as the position locator feature and the position index feature.

The small end is configured to apply a second inward axial force. For illustrative purposes only FIGS. 1A, 1B, 2A, 2B, 5A, 5B, 6A and 6B show embodiments of the axle with the small end configured to apply the second inward axial force by a fastener nut 39 that receives the threaded tip 32 of the small end. FIG. 3 shows the embodiment of the axle with the second end configured to apply the first inward axial force by a bolt 42 received by the threaded bore 41 of the small end. It is obvious to a person having ordinary skill in the art that a plurality of fasteners and small end configurations could be used to apply the second axial force, the second inward axial force ultimately applied to a bearing 12 of the second side 13a of the wheel hub.

For illustrative purposes only, the embodiments of FIGS. 1A and 2A show the small step 34 located approximately at the inner face 54 of the second fork axle housing 9. FIGS. 1B and 2B show the small step having a fillet 8 to ease the inside corner of the small step and relieve stress, the second spacer 11 is located on the center section between the second fork axle housing and the bearing of the second side of the wheel hub 13a. A flange of the spacer directly abuts the inner face 54 of the second fork axle housing, the flange has sufficient diameter and thickness to reinforce the connection between the small end and the second fork axle housing. It is obvious to a person having ordinary skill in the art that a plurality of configurations could be used for the small end, the small step, the second spacer, the bearing of the second side of the wheel hub, and the second fork axle housing in order to transfer the second inward axial force applied by the fastener to the wheel hub first side.

A center section diameter is selected and a desired offset range is selected. The large end diameter is equal to or greater than the sum of the selected center section diameter and the selected offset range. The small end diameter is equal to less the sum of the selected center section diameter and the selected offset range.

The inventive axle can be configured with a plurality of diameters and offset ranges. An axle size is designated by a center section diameter followed by an offset range with an “x”, e.g., 25 mm×6 mm or 1 inch×¼ inch. The axle can have a hollow center. The axle and ancillaries could be designed in reverse fashion with a large end housed in the second front fork axle housing and a small end housed in the first front fork axle housing.

Although preferred embodiments of this invention have been described above with a certain degree of particularity, a person having ordinary skill in the art could make numerous alterations to the disclosed embodiments without departing from the spirit or scope of this invention as described in the specification, drawings and claims. Different materials and design details could be used, such as a hollow axle design for weight reduction, without departing from the spirit or scope of this invention as described in the specification, drawings and claims. All references (e.g., large end, center section, small end, offset, offset range, first fork, second fork, side, ends axis, center axis, large end step, small step, large end step range, continuous large end step, small step fillet, spacers) are only used for identification purposes to aid the reader's understanding of the present invention, and do not create limitations, particularly as to the position, orientation, or use of the invention. Joinder references (e.g., attached, coupled, connected, secured, fixed, and the like) are to be construed broadly and may include intermediate members between a connection of elements and relative movement between elements. As such, such joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the claims.

1. An offset axle and ancillaries have a means to adjusts steering and handling characteristics of a motorcycle or a bicycle, herein referred to as a cycle, the axle connects a front wheel of the cycle to two front forks of the cycle, the axle adjusts a rotational axis of the front wheel to a plurality of positions relative to the forks of the cycle, each position of the front wheel rotational axis results in a respective combination of steering and handling characteristics for the cycle.

2. The axle and ancillaries of claim 1, wherein the axle is integrally formed as a single structure, a first end of the axle is a large end of a cylindrical form with an eccentric large end step, a second end of the axle is a small end of a cylindrical form, a diameter of the small end is less than a diameter of the large end, the small end is concentric with the large end.

3. The axle and ancillaries of claim 2, wherein a center section of the axle is located between the large end and the small end, the center section is eccentric to, and offset from the large end and the small end, the center section is a cylindrical form with an eccentric small step adjacent to the small end.

4. The axle and ancillaries of claim 3, wherein a diameter of the center section is smaller than the large end diameter and larger than the small end diameter, the center section locates and supports the front wheel, the rotational axis of the front wheel is shared with an axis of the cylindrical center section.

5. The axle and ancillaries of claim 4 wherein the large end of the axle is housed in an axle housing of the first fork, the small end of the axle is housed in an axle housing of the second fork.

6. The axle and ancillaries of claim 5, wherein, the small end is configured with a distally located fastener to fasten the axle and wheel to the axle housing of the first fork and the axle housing of the second fork.

7. The axle and ancillary elements of claim 6, wherein the large end includes a position locator feature configured to indicate the position of the center section axis relative to the first fork, the axle housing of the first fork has a position index feature configured to reference the position locator feature of the large end.

8. The axle and ancillary elements of claim 7, wherein the large end of the axle includes an engagement feature to provide rotational engagement to torque the axle, the large end engagement feature provides axial engagement to extract the axle from an installed position.

9. The axle and ancillaries of claim 8, wherein the axle can be rotated within the axle housings to a plurality of rotational positions by engagement of the large end engagement feature, the axle is rotated to a desired rotational position, the desired axle rotational positon locates the front wheel rotational axis at a desired position, the desired position of the front wheel rotational axis has a desired combination of handling and steering characteristics for the cycle.

10. The axle and ancillaries of claim 9, wherein the desired axle rotational position is secured by rotational securement of the large end of the axle, the desired axle rotational position may be secured by optional redundant rotational securement of the small end of the axle.

11. The axle and ancillaries of claim 10, wherein the rotational securement of the large end of the axle is provided by direct rotational engagement of the large end by the axle housing of the first fork.

12. The axle and ancillaries of claim 11, wherein the optional redundant rotational securement of the small end of the axle is made by direct rotational engagement of the small end by the axle housing of the second fork.

13. The axle and ancillaries of claim 12, wherein the large end is configured to apply a first inward axial force, the first inward axial force ultimately applied to a bearing of a first side of a hub of the front wheel, the fastener of the small end is configured to apply a second inward axial force, the second inward axial force ultimately applied to a bearing of a second side of a hub of the front wheel.

14. The axle and ancillaries of claim 13, wherein a front brake caliper mount has the means to allow a brake caliper to be mounted in a plurality of positions relative to the front wheel.
